(19) United States
(12) Patent Application Publication
(10) Pub. No.: US 2025/0353393 A1
(43) Pub. Date: Nov. 20, 2025

(54) CHARGING DEVICE

(71) Applicant: PA KNOWLEDGE LIMITED, London, Greater London (GB)

(72) Inventors: David Murray CROSS, Hertfordshire (GB); Stuart Michael Ruan JONES, Hertfordshire (GB)

(73) Assignee: PA KNOWLEDGE LIMITED, London, Greater London (GB)

(21) Appl. No.: 18/870,816

(22) PCT Filed: Jun. 1, 2023
(86) PCT No.: PCT/GB2023/051447

§ 371 Date: Dec. 2, 2024

(30) Foreign Application Priority Data
Jun. 1, 2022 (GB) 2208105.3

(51) Int. Cl. B60L 53/31; B60L 53/16; B60L 53/18

(52) U.S. Cl. CPC B60L 53/31; B60L 53/16; B60L 53/18

(57) ABSTRACT

According to a first aspect of the disclosure there is provided a cable store for a charging device, the charging device for charging and/or discharging an electrical device, the cable store comprising: a drum portion around which a cable of the charging device is configured to be wound; a deflection portion configured to deflect the cable to wind around the drum portion; wherein the cable is configured to enter the deflecting portion substantially in a direction corresponding to an axial direction of the drum portion and wind around the drum portion substantially in a direction corresponding to a circumferential direction of the drum portion.

### TECHNICAL FIELD

The present disclosure relates to charging devices for charging and/or discharging an electrical device. For example, the electrical device may be an electrical vehicle, a battery for an electric vehicle or a charger for an electric vehicle.

### BACKGROUND ART

Electric vehicles typically include a fixed charging port in the main body of the vehicle. The fixed charging port can be connected to a tethered outlet connector of an AC or DC charger. The fixed charging port can also be connected to a fixed outlet port of an AC charger, or an electrical load, using an accessory cable carried by the vehicle and connected by the user. Unfortunately, accessory cables carried by the vehicle and connected by the user are inconvenient to use and not accessible to all potential users in the transition to electric vehicles.

Functional requirements for charging electric vehicles include ease of use, high reliability, low weight, and high efficiency of the space envelope occupied by the charging port and the cable when retracted. Whilst retractable charging cables partially address at least some of the user inconvenience and accessibility problems with AC charging, only a subset of retractable cable device configurations will have high volumetric efficiency.

Revolving drum, spool or reel configurations of cable stores are known. However, the cable configuration necessary to connect the revolving drum to the electrical device often occupies a relatively large percentage of the space envelope of the cable store.

Further, public on-street charging is an important part of electric vehicle infrastructure. However local authorities prefer not to have chargers with fixed length or retractable cables, in case these are not properly stowed away by users. Unfortunately, accessory cables carried by the vehicle and connected by the user are inconvenient to use and can be lost.

It is an aim of the present disclosure to at least partially address some of the above problems.

### SUMMARY OF THE INVENTION

According to a first aspect of the disclosure there is provided a cable store for a charging device, the charging device for charging and/or discharging an electrical device, the cable store comprising: a drum portion around which a cable of the charging device is configured to be wound; a deflection portion configured to deflect the cable to wind around the drum portion; wherein the cable is configured to enter the deflecting portion substantially in a direction corresponding to an axial direction of the drum portion and wind around the drum portion substantially in a direction corresponding to a circumferential direction of the drum portion.

Optionally, the drum portion is stationary. Optionally, the deflecting portion is stationary.

Optionally, the cable store is configured such that the cable automatically winds around the drum portion as the cable is moved into the deflecting portion.

Optionally, the drum portion comprises inner and outer drum portions forming a cavity therebetween. Optionally, the cavity is configured to constrain the movement of the cable in a direction substantially perpendicular to a surface of the drum portion, but is configured to permit movement in a direction parallel to a surface of the drum portion.

Optionally, the deflecting portion comprises inner and outer deflecting portions forming a cavity therebetween. Optionally, the cavity is configured to constrain the movement of the cable in a direction substantially perpendicular to a surface of the deflecting portion, but is configured to permit movement in a direction parallel to a surface of the deflecting portion.

Optionally, the cavity between the inner and outer drum portions is continuous with the cavity between the inner and outer deflecting portions.

Optionally, the deflecting portion comprises an opening through which the cable enters the deflecting portion.

Optionally, the drum portion has a substantially circular or oval cross-section.

Optionally, the deflecting portion is a convex portion arranged at one end of the drum portion.

Optionally, the deflecting portion comprises a dome portion configured to deflect the cable to the drum portion.

Optionally, the deflecting portion comprised a tapered-portion configured to deflect the cable to the dome portion. Optionally, the tapered portion is substantially cone-shaped.

Optionally, the cable store comprises at least one liquid egress opening associated with the for removal of liquid.

According to a second aspect of the disclosure there is provided a charging device for charging and/or discharging an electrical device, the charging device comprising: a cable; and a cable store according to the first aspect.

Optionally, the cable comprises one or more mechanical slip rings configured to allow different portions of the cable to rotate relative to each other.

Optionally, the cable comprises an outer conduit and inner electrical cables, and the different portions of the outer electrical conduit portions are configured to rotate relative to each other.

Optionally, the mechanical slip ring comprises first and second parts connected together, the first part being inserted into the second part to form a mechanical connection between first and second sections of the cable that allows rotation of the first and second sections of the cable. Optionally, the first part comprises one or more clips configured to connect the first part to the second section of the cable, and the second part comprises an O-ring configured to form a seal between the second section of the cable and an outer wall of the first part.

Optionally, the charging device further comprises a connector at a distal end of the cable, the connector being configured to connect the charging device to a second electrical device for charging and/or discharging the electrical device.

Optionally, the connector is configured to perform AC charging and/or discharging.

Optionally, the connector has an arrangement corresponding to a CCS2 standard or a Type 2 standard.

Optionally, the cable is configured to be manually moved into and/or out of the cable store.

Optionally, the charging device comprises a cable drive unit, configured to drive the cable into and/or out of the cable store.

Optionally, the cable drive unit is operable by a switch located on the connector.

Optionally, the cable drive unit is operable by a switch located on the outer charging port casing or on the electrical device.

Optionally, the charging device comprises one or more sensors configured to sense cable position and/or cable speed, and a control device configured to control the drive unit based on the sensed cable position and/or speed.

Optionally, the cable drive unit comprises a cable drive mechanism configured to engage with an outer surface of the cable. Optionally, the outer surface of the cable is textured to enable engagement with cable drive mechanism. Optionally, the outer surface of the cable is convoluted.

According to a third aspect of the disclosure, there is provided an electric vehicle comprising the cable store or charging device of the first or second aspects, wherein the electric vehicle is the electrical device.

According to a third aspect of the disclosure, there is provided a charger for an electric vehicle comprising the cable store or charging device of the first or second aspects, wherein the charger is the electrical device.

According to a fourth aspect of the disclosure there is provided a charging device for charging and/or discharging an electrical device, comprising: an outer charging port casing comprising an opening and fixed with respect to the electrical device; an inner charging port casing arranged within the opening of the outer charging port casing and detachable from the outer charging port casing; one or more inner electrical contacts arranged within the inner charging port casing and configured to connect with one or more corresponding electrical contacts of a second electrical device to charge and/or discharge the electrical device; a cable mechanically connected to the inner charging port casing and electrically connected to the one or more electrical contacts; wherein the inner charging port casing is configured to be detached and separated from the outer charging port casing to connect to the second electrical device, and as the inner charging port casing is separated from the outer charging port casing, the cable extends through the opening.

Optionally, the charging device is operable in a first mode and a second mode, in the first mode the charging device is connected to the further electrical device when the inner charging port casing is attached to the outer charging port casing; and in the second mode the charging device is connected to the further electrical device, via the inner charging port casing, when the inner charging port casing is detached from the outer charging port casing.

Optionally, the one or more inner electrical contacts are configured to perform AC charging and/or discharging.

Optionally, the inner charging port casing has an arrangement corresponding to a CCS2 standard or a Type 2 standard.

Optionally, the outer charging port casing comprises one or more outer electrical contacts configured to connect with one or more corresponding electrical contacts of the second electrical device to charge and/or discharge the electrical device.

Optionally, one or both of the inner electrical contacts and the outer electrical contacts are configured to connect with one or more corresponding electrical contacts of the second electrical device to charge the electrical vehicle.

Optionally, the one or more outer electrical contacts are configured to perform DC charging.

Optionally, the outer charging port casing has an arrangement corresponding to a CCS2 standard.

Optionally, the cable is configured to be manually moved into and/or out of the opening.

Optionally, a cable drive unit, configured to drive the cable into and/or out of the opening.

Optionally, the cable drive unit is operable by a switch located on the inner charging port casing.

Optionally, the cable drive unit is operable by a switch located on the outer charging port casing or on the electrical device. Optionally, the charging device comprises one or more sensors configured to sense cable position and/or cable speed, and a control device configured to control the drive unit based on the sensed cable position and/or speed. Optionally, the cable drive unit comprises a cable drive mechanism configured to engage with an outer surface of the cable. Optionally, the outer surface of the cable is textured to enable engagement with cable drive mechanism. Optionally, the outer surface of the cable is convoluted.

Optionally, the cable comprises one or more mechanical slip rings configured to allow different portions of the cable to rotate relative to each other.

Optionally, the charging device further comprises a cable store configured to store the cable. Optionally, the cable is configured to be wound in the cable store. Optionally, the cable store comprises: a drum portion around which the cable is configured to be wound; and a deflection portion configured to deflect the cable to wind around the drum portion.

Optionally, the cable store comprises: inner and outer drum portions forming a cavity there between; inner and outer dome portions connected to the drum portions forming a cavity there between; and inner and outer tapered portions connected to the dome portions forming a cavity there between and an opening in the end of the outer tapered portion through which the cable passes; wherein an end of the cable is fixedly connected at the inner and outer drum portions, and as the cable is fed into the opening, the cable is deflected by the tapered portions and the dome shaped portions in such way as to wind around the inner dome shaped portion.

Optionally, the inner charging port casing is moveable between a first position in which the inner charging port casing is positioned further into the outer charging port casing, to a second position in which the inner charging port casing is less far into the outer charging port casing.

Optionally, the charging device comprises at least one liquid egress opening associated with the inner charging port casing for removal of liquid.

According to a further aspect of the invention there is provided a cable store comprising: inner and outer drum portions forming a cavity there between; inner and outer dome portions connected to the drum portions forming a cavity there between; and inner and outer tapered portions connected to the dome portions forming a cavity there between and an opening in the end of the outer tapered portion through which the cable passes; wherein an end of the cable is fixedly connected at the inner and outer drum portions, and as the cable is fed into the opening, the cable is deflected by the tapered portions and the dome shaped portions in such way as to wind around the inner dome shaped portion.

According to a further aspect of the disclosure there is provided an electric vehicle comprising the charging device of the fourth aspect, wherein the electric vehicle is the electrical device.

According to a further aspect of the disclosure there is provided a charger for an electric vehicle comprising the charging device of the fourth aspect, wherein the charger is the electrical device.

### BRIEF DESCRIPTION OF THE DRAWINGS

Further features and advantages of the disclosure are described below by way of non-limiting examples and with reference to the accompanying drawings, in which:

FIG. 1 shows a first view of an example charging device;

FIG. 2 shows a second view of the example charging device;

FIG. 3 shows a third view of the example charging device;

FIG. 4 shows an example plug-socket arrangement;

FIG. 5 schematically shows an example cable drive system;

FIG. 6 shows an example cable drive unit;

FIG. 7 shows an example cable store;

FIG. 8 shows an example winding arrangement of the cable;

FIG. 9 shows a first view of an example mechanical slip ring arrangement;

FIG. 10 shows a second view of the example mechanical slip ring arrangement;

FIG. 11 shows a first view of an example inner charging port casing moving system;

FIG. 12 shows a second view of the example inner charging port casing moving system;

FIG. 13 shows an example liquid egress system

FIG. 14 shows examples of first and second electrical devices comprising an example charging device;

FIG. 15 shows examples of first and second electrical devices comprising an example charging device;

FIG. 16 shows examples of first and second electrical devices comprising an example charging device;

FIG. 17 shows comparative examples of serpentine cable stores and the percentage of space envelope utilised by the retracted cable;

FIG. 18 shows examples of wound conduit stores and the percentage of space envelope utilised by the retracted cable according to the disclosure;

FIG. 19 shows an example cable and connector extending from an example cable store in an example on-street charger to an example charging port in an example electric vehicle; and

FIG. 20 shows an example cable and connector extending from an example cable store in an example electric vehicle to an example charging port in an example on-street charger.

### DETAILED DESCRIPTION

A charging device according to the disclosure may comprise a connector and a cable for charging and/or discharging a first electrical device. The first electrical device may be an electric vehicle or a charger for an electric vehicle for example. The charging device may form a part of the first electrical device, in some examples.

The cable may be electrically connected to a part of the electric device to be charged and/or discharged, such as an electrical power source or electrical power storage means, e.g. a battery. The connector may be configured to connect the cable (and thus the part of the electrical device) to an external electrical power source for charging, or an external electrical power sink for discharging. The external electrical power source and/or external electrical power sink may be provided by a second electrical device. The second electrical device may be a charger for an electric vehicle or an electric vehicle, for example.

The connector may comprise electrical contacts, electrically connected to the cable. The electrical contacts may be housed in a casing of the connector. The cable may be mechanically connected to the casing. The connecter may be configured to connect to a corresponding connector that is connected to, or part of, a second electrical device for charging and/or discharging the first electrical device. The connector of the charging device may have a plug-socket arrangement with the corresponding connector.

In examples described below, the connector may be a charging port or part of a charging port, for example.

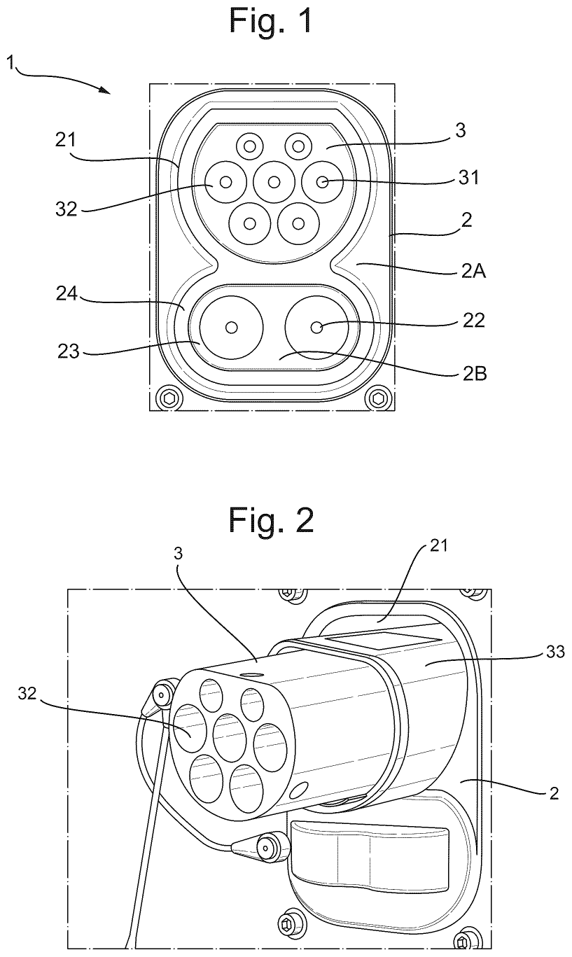

FIGS. 1, 2 and 3 respectively show first, second and third views of an example charging device 1 according to the disclosure. The charging device 1 is for charging and/or discharging a first electrical device 100. The charging device 1 may form a part of the first electrical device 100, in some examples.

As shown in FIGS. 1 to 3, the charging device 1 may comprise an outer charging port casing 2 and an inner charging port casing 3. Together, the outer charging port casing 2 and an inner charging port casing 3 may form a charging port. As shown, the outer charging port casing 2 comprises an opening 21. The inner charging port casing 3 is arranged within the opening 21 of the outer charging port casing 2.

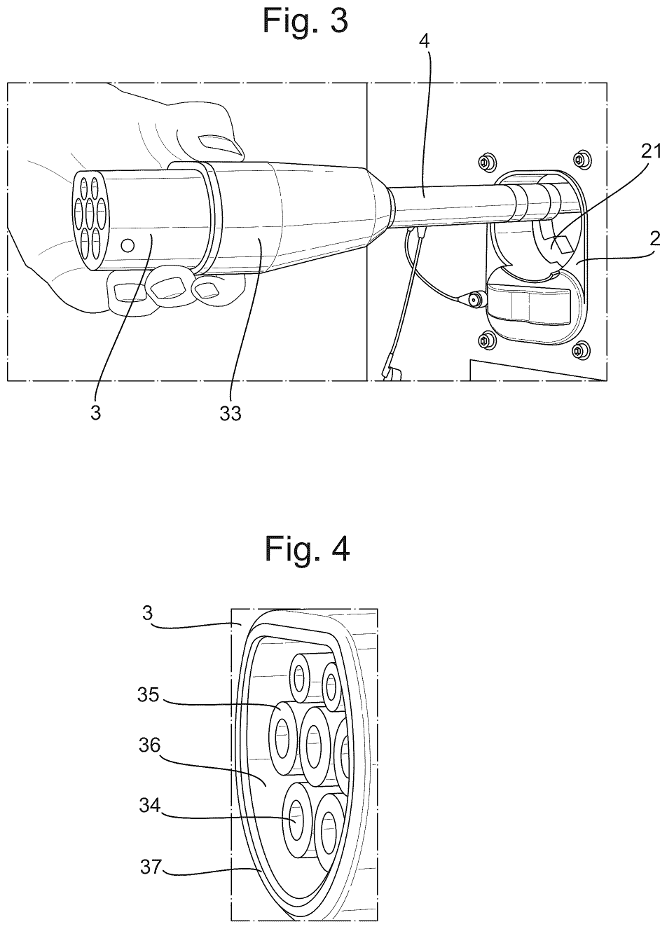

The outer charging port casing 2 may be fixed in position with respect to the electrical device 100. The inner charging port casing 3 may be detachable from the outer charging port casing 2, as shown in FIGS. 2 and 3. Specifically, the inner charging port casing 3 may be configured to be detached and separated from the outer charging port casing 2 in order to connect the inner charging port casing 3 to a second electrical device 200. The second electrical device 200 may provide charge (e.g. act as a power source) for charging the first electrical device 100 and/or receive charge (e.g. act as a power sink) discharged by the first electrical device 100.

As shown in FIG. 1, the charging device 1 comprises one or more inner electrical contacts 31 arranged within the inner charging port casing 3. The inner electrical contacts 31 may be configured to connect with one or more corresponding electrical contacts associated with the second electrical device 200 to charge and/or discharge the first electrical device 100. The corresponding electrical contacts may be part of a second electrical device. The second electrical device 200 may form a part of the second electrical device 200. The second electrical device 200 may also be constructed as described above, in some examples.

As shown in FIG. 3, the charging device 100 may comprise a cable 4 mechanically connected to the inner charging port casing 3. The cable 4 may be electrically connected to the one or more electrical contacts 31. As shown in FIG. 3, the charging device 1 may be configured such that, as the inner charging port casing 3 is separated from the outer charging port casing 2, the cable 4 extends through the opening 21 within the outer charging port casing 2.

As shown in FIG. 1, the outer charging port casing 2 may comprise one or more outer electrical contacts 22. The one or more outer electrical contacts 22 may be configured to connect with one or more corresponding electrical contacts of the second electrical device 200, to charge and/or discharge the electrical device 100.

FIGS. 1 and 3 show the charging device 1 in a first mode and second mode of operation respectively. In the first mode, shown in FIG. 1, the charging device 1 is configured to be connected to the second electrical device 200 when the inner charging port casing 3 is attached to the outer charging port casing 2. In the first mode, the charging device 1 behaves as a fixed charging port.

In the first mode, the charging device 1 may be mechanically connected to the second electrical device 200 via the inner charging port casing 3 and/or the outer charging port casing 2. In the first mode, the charging device 1 may be electrically connected to the second electrical device 200 via inner electrical contacts 31 and/or outer electrical contacts 21.

In the second mode, shown in FIG. 3, the charging device 1 is configured to be connected to the second electrical device 200 when the inner charging port casing 3 is separated from the outer charging port casing 2. In the second mode, the charging device 1 behaves as a tethered charging port.

In the second mode, the charging device 1 may be mechanically connected to the second electrical device 200 via the inner charging port casing 3 only. In the second mode, the charging device 1 may be electrically connected to the second electrical device 200 via inner electrical contacts 31 only.

When the charging device is connected to the second electrical device 200, all or a subset of the inner electrical contacts 22 may provide an electrical connection to the second electrical device 200. Similarly, all or a subset of the outer electrical contacts 22 may provide the electrical connection.

Different subsets of inner electrical contacts 31 or outer electrical contacts 22 may be configured to perform different types of charging/discharging, e.g. AC or DC charging/discharging. Different subsets of inner electrical contacts 31 or outer electrical contacts 22 may be configured to connect to different types of second electrical devices 200.

As shown in FIG. 3, the inner charging port casing 3 may be mechanically connected to a casing 33 configured to be held by the user when connecting the inner charging port casing 3 to the second electrical device 200. As shown, the casing 33 may be mechanically connected to the cable 4.

A portion of the opening 21 within the outer charging port casing 2 and the casing 33 may be correspondingly shaped so as to engage with each other. For example, they may be shaped such that they have a friction fit that secures the inner charging port casing 3 in position within the opening 21.

The outer and inner charging port casings 2, 3, together or separately, may be configured to engage with a corresponding port associated with the second electrical device 200, in a plug-socket arrangement. The recesses 32 may be cylindrical in shape, as shown. Each of the outer and inner charging port casings 2, 3 may have male and/or female connecting parts respectively configured to engage with female and/or male connecting parts associated with the second electrical device 200.

As shown in FIG. 1, the inner electrical contacts 31 may be arranged within recesses 32 within the inner charging port casing 3. Each of the recesses 32 provides a female connecting part. The inner charging port casing 3 in which the recesses 32 are provided provides a male connecting part. As shown, a part of the opening 21 may provide a channel surrounding the inner charging port casing 3. The channel may provide a female connecting part, when the charging device is in the first mode of operation.

As shown in FIG. 1, the outer charging port casing 2 may be divided into two portions, namely an outer portion 2A and an inner portion 2B. As shown, the outer portion 2A may surround the inner portion 2B and the inner charging port casing 3. As shown, the opening 21 may be provided in the outer portion 2A. As shown, a channel 24 may be provided between the outer portion 2A and the inner portion 2B.

As shown in FIG. 1, the outer electrical contacts 22 may be arranged within recesses 23 within the inner portion 2B of the outer charging port casing 2. Each of the recesses 23 provides a female connecting part. The inner portion 2B, in which the recesses 23 are provided, provides a male connecting part. As shown, the channel 24 surrounding the inner portion 2B provides a female connecting part.

FIG. 4 shows a plug-socket arrangement configured to connect with the plug-socket arrangement of the inner charging port casing 3 shown in FIG. 1. As shown in FIG. 4, electrical contacts 34 may be arranged within protrusions 35, providing male connecting parts configured to engage with the recesses 32. A hollow portion 36 surrounding the protrusions 35 provides a female connecting part configured to engage with the inner charging port casing 3. A perimeter wall 37 surrounding the hollow portion provides a male connecting part configured to surround the inner charging port casing 3 and/or engage with the channel formed by the opening 21 in the outer charging port casing 2.

Although not shown, a plug-socket arrangement configured to connect with the plug-socket arrangement of the inner portion 2B of the outer charging pot casing may comprise electrical contacts arranged within protrusions, providing male connecting parts configured to engage with the recesses 23; a hollow portion surrounding the protrusions providing a female connecting part configured to engage with the inner portion 2B; and a perimeter wall surrounding the hollow portion providing a male connecting part configured to surround the inner portion 2B and engage with the channel 24.

In alternative examples, the charging device 1 may have the plug-socket arrangements described immediately above, including the arrangement shown in FIG. 4, instead of the arrangement shown in FIG. 1. Alternative arrangements not specifically described herein could also be used.

In the example shown in FIGS. 1 to 3, the inner charging port casing 3 has a plug-socket arrangement corresponding to a CCS2 standard port (outer and inner charging port casing 2, 3) or a Type 2 standard port (inner charging port casing 3) used for electric vehicles. In such arrangement the electrical contacts within charging port casing 3 are used for AC charging/discharging and the electrical contacts within the charging port portion 2B are used for DC charging/discharging.

In other example charging devices according to the disclosure, the charging port may be provided in a different way to the example described above.

The charging device may be suitable for distributing AC or DC power, e.g. around 7.4 kW for single phase AC power, around 22 kW for three-phase AC power, or more than 50 kW for DC power.

The cable 4 may be retractable into and extendable out of the charging device. The charging device 1 may be a retractable cable device, for example.

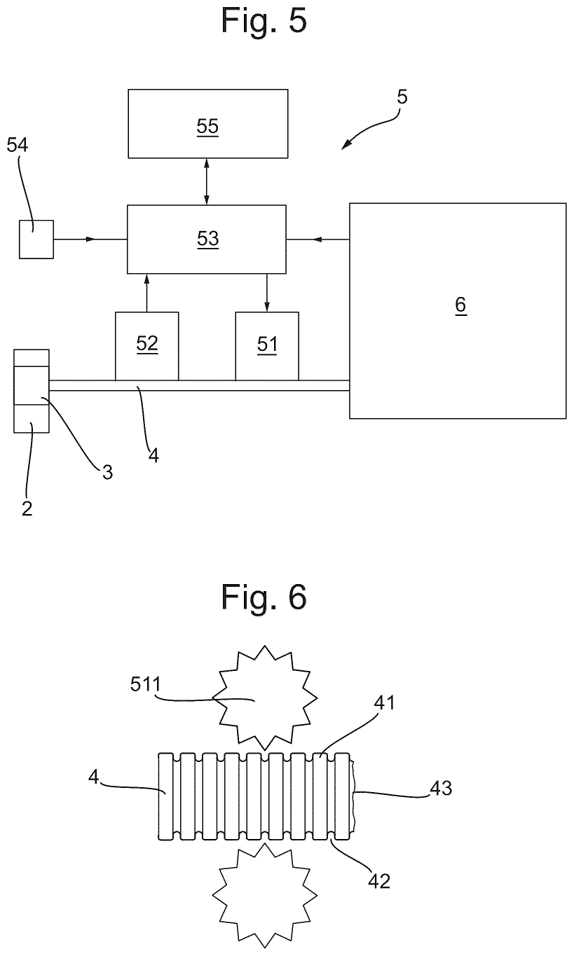

FIG. 5 schematically shows a cable drive system 5 according to the disclosure. As shown in FIG. 5, the cable drive system 5 may comprise a cable drive unit 51 configured to drive the cable 4. The cable drive unit 51 may be configured to drive the cable 4 out of and/or into the first electrical device 100, i.e. in forward and/or backward directions respectively. In the example charging device 1 shown in FIGS. 1 to 3, the cable drive unit 51 may be configured to drive the cable out of and/or into the opening 21 in the outer charging port casing 2, i.e. in forward and/or backward directions respectively. Accordingly, the cable 4 may be extendable and/or retractable.

The cable drive system 5 may further comprise a sensor unit 52 configured to sense the cable position and/or cable speed when the cable 4 is driven by the cable drive unit 51. The cable drive system 5 may further comprise a control unit 53 configured to control the cable drive unit 51. For example, the control unit 53 may be configured to control the drive unit 51 based on the cable position and/or cable speed sensed by the sensor unit 52. For example, the driving speed may be slowed and/or stopped as the cable position approaches full extension or full retraction.

The cable drive system 5 may further comprise a switch 54 to start, stop and/or change the direction of the driving of the cable 4 by the cable drive unit 51. The switch 54 may be operably connected to the control unit 53. The control unit 53 may be operably connected to a general control unit 55 of the electrical device 100 to which the charging device 1 is connected. For example, this may be a general control unit of an electric vehicle or electric vehicle charger.

The switch 54 may be provided anywhere that is accessible to a user. In the example charging device 1 shown in FIGS. 1 to 3, the cable drive switch 54 may be provided next to the outer charging port casing 2 and/or connected to the inner charging port casing 3, e.g. on the casing 33.

A portion of the cable 4 may be stored in a cable store 6. Wiring connecting the cable drive switch 54, e.g. if connected to the inner charging port casing 3, may pass through the cable 4 and be operably connected to the control unit 53 via the cable store 6, as shown in FIG. 5.

The internal components shown schematically in FIG. 5, e.g. cable drive unit 51, sensor unit 52 and control unit 53, may be integrated or discretely distributed to best fit within an enclosure of the electrical device 100.

FIG. 6 shows an example cable drive unit 51. The cable drive unit 51 may comprise a cable drive mechanism, configured to engage with the cable 4, e.g. an outer surface thereof. As shown in FIG. 6, the cable drive mechanism, may comprise one or more drive gears 511. The drive gears 511 may be configured to rotate to drive the cable 4. As shown in FIG. 6, the outer surface of the cable 4 may be textured so as to enable engagement with the cable drive mechanism. For example, as shown in FIG. 6, the outer surface may be convoluted. As shown, the outer surface may comprise protrusions 41 and recesses 42. Teeth of the drive gears 511 may be configured to engage with the recesses 42 to drive the cable 4.

As shown in FIG. 6, the cable 4 may comprise a hollow inner portion 43 for accommodating electrical wiring (e.g. internal insulated electrical cables), e.g. for the switch 54 and electrical contacts of the connector (e.g. the inner electrical contacts 31). Accordingly, the outer layer of the cable 4 may be a conduit. The conduit may be flexible.

The cable 4 may be manually moveable in the forward and backward directions, e.g. in the event that the cable drive unit stops working.

FIG. 7 shows an example cable store 6. The cable 4 may be un-stored and stored as the cable 4 is moved in the forward and backward directions respectively.

The cable store 6 may comprise a drum portion around which the cable 4 is configured to be wound. The cable 4 may be unwound from and wound around the cable store as the cable 4 is moved in the forward and backward directions respectively. The cable store 6 may comprise a deflecting portion configured to deflect the cable to wind around the drum portion.

The cable 4 may be configured to enter the deflecting portion substantially in a direction corresponding to an axial direction of the drum portion and wind around the drum portion substantially in a direction corresponding to a circumferential direction of the drum portion. The cable store 6 may be configured such that the cable 4 automatically winds around the drum portion as the cable is moved into the deflecting portion. This may occur simply by movement of the cable into the deflecting portion and then the drum portion.

As shown, the drum portion may comprise inner and outer drum portions 61a, 61b forming a cavity 61 therebetween. The drum portion (e.g. inner and outer drum portions) may be stationary. In other words, the drum portion are not configured to move in order for the cable to be wound and unwound. This is different to a spool arrangement with a rotating drum.

As shown in FIG. 6, the deflection portion may comprise inner and outer dome portions 62a, 62b connected to the drum portions 61a, 61b forming a cavity 62 there between, inner and outer tapered portions 63a, 63b connected to the dome portions 62a, 62b and forming a cavity 62 there between and an opening 64 in the end of the outer tapered portion 63b. The opening 64 may be connected to a conduit 65. The deflecting portion (e.g. inner and outer dome and tapered portions) may be stationary. In other words, the deflecting portion is not configured to move in order for the cable to be wound and unwound.

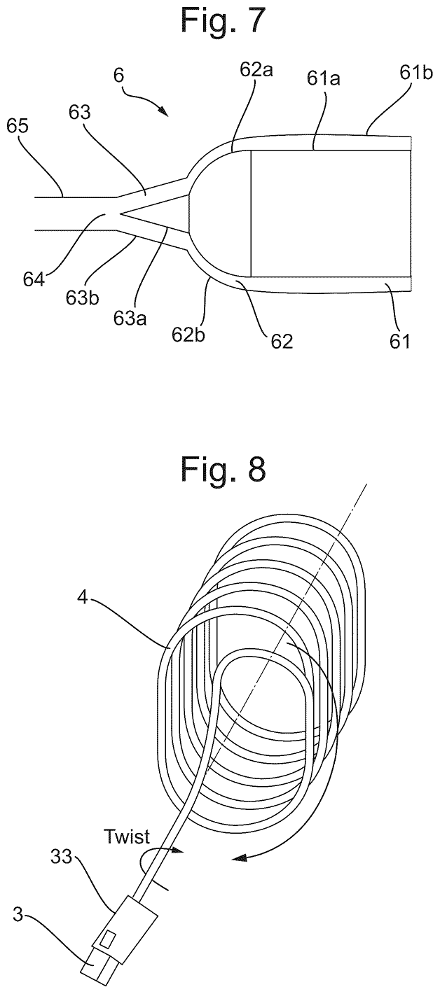

The cavity 61, 62, 63 and the conduit 65 may provide a continuous space for storing the cable 4. Preferably, the width of these cavities is substantially the width of the cable 4, to direct the cable 4, but slightly larger to allow movement of the cable through the cavity 61, 62, 63. As the cable 4 is fed into the opening 64, the cable 4 is deflected by the tapered portions 63a, 63b and the dome shaped portions 62a, 62b, in such a way as to wind around the inner drum portion 61a, as shown in FIG. 8.

An end of the cable 4, opposite the inner charging port casing 3, may be fixedly connected at the inner and outer drum portions 61a, 61b, e.g. at and end opposite to the opening 64. If such a fixed connection is provided, the cable 4 has a tendency to twist as the cable 4 winds around the inner drum portion 61a, as shown by the arrows in FIG. 8. In order to mitigate this, sections of the cable 4 may be independently rotatable relative to each other. For example, the outer layer of the cable 4, i.e. the conduit, may have such an arrangement. Electrical wiring running through the conduit may not have such an arrangement and may be allowed to twist.

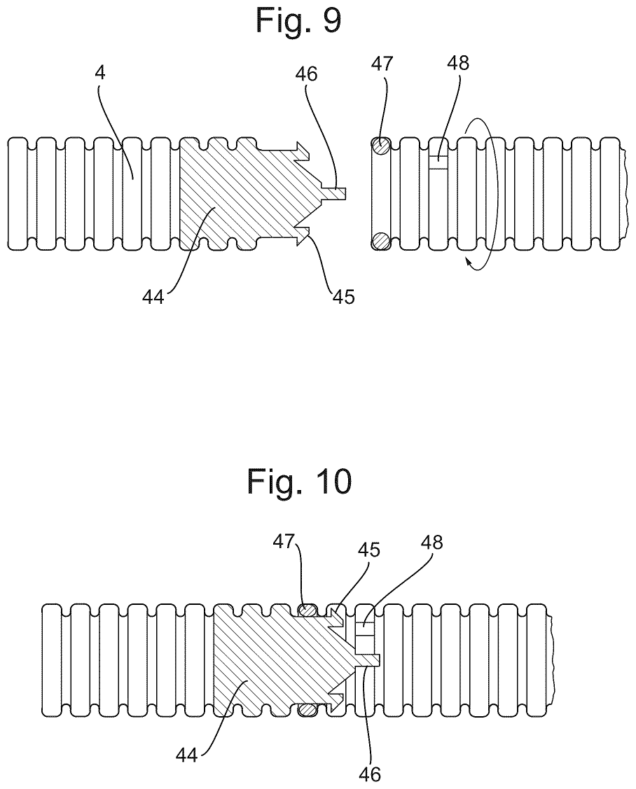

The cable 4 may comprise one or more mechanical slip rings that allow two portions of the cable 4 (e.g. the conduit) to rotate relative to each other to reduce mechanical strain on the cable 4 from winding in the cable store 6. FIGS. 9 and 10 show an example of a mechanical slip ring arrangement.

As shown in FIGS. 9 and 10, the mechanical slip ring arrangement may comprise two parts connected to respective first and second sections of the cable 4 (e.g. the conduit) to be joined. As shown in FIGS. 9 and 10, the cable 4 (e.g. the conduit) may comprise a first part 44 and a second part 47. As shown in FIG. 10 the first part 44 may be inserted into the second part 47 to form a mechanical connection between first and second sections of the cable 4 that allows rotation of the first and second sections of the cable 4 (e.g. the conduit).

As shown in FIGS. 9 and 10, the first part 44 may comprise clips 45 configured to connect the first part 44 to the second section of the cable 4. As shown in FIG. 10, the clips 45 may engage with an inner wall of the cable 4 (e.g. the conduit), e.g. between a protruding portion 41 and a recess portion 42 of the cable 4 (e.g. the conduit), to prevent disengagement of the two sections of the cable 4 (e.g. the conduit). The second part 47 may comprise an O-ring configured to form a seal with an outer wall of the first part 44, as shown in FIG. 10. The O-ring may engage with an inner wall of the cable 4 (e.g. the conduit), e.g. between a protruding portion 41 and a recess portion 42 of the cable 4 (e.g. the conduit).

Additionally, as shown, the first part 44 may comprise a first abutment member 46 configured to contact a corresponding second abutment member 48 provided on the second section of the cable 4 (e.g. the conduit), to limit rotation of the first and second sections of the cable 4 (e.g. the conduit).

Alternative mechanical slip ring arrangements may be provided instead of the example shown in FIG. 9 and FIG. 10.

The mechanical slip rings arrangements may be are spaced apart along the length of the cable 4 by approximately the length of one whole turn of the cable 4 wound within the cable store.

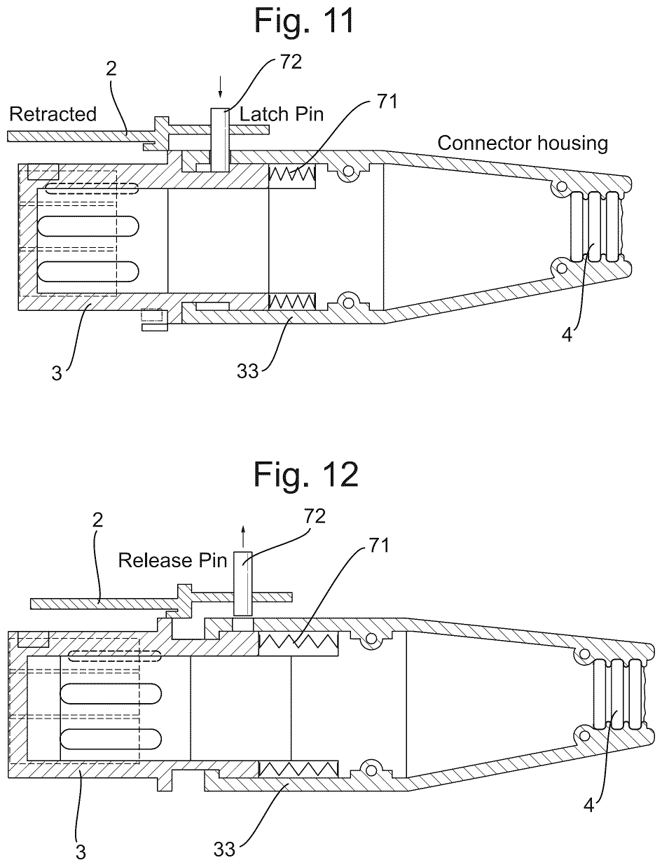

Some standard charging ports have different offset distances between the outer charging port casing 2 and the inner charging port casing 3. Accordingly, it may be advantageous to provide a charging device 1 that can change from one arrangement to the other. FIGS. 11 and 12 show such an arrangement. As shown, the inner charging port casing 3 may be moveable from a first position, shown in FIG. 11, in which the inner charging port casing 3 is positioned further into the outer charging port casing 2, to a second position, shown in FIG. 12, in which the inner charging port casing 3 is less far into the outer charging port casing 2.

As shown, the inner charging port casing 3 may be retained by the casing 33 and biased against a portion of the casing 33, towards the second position, by a spring 71. A locking mechanism, e.g. releasable pin 72, may be provided to the outer charging port casing 2 that is configured to lock the inner charging port casing 3 in the first position, as shown in FIG. 11. As shown, the pin 71 may engage with the casing 33 and the inner charging port casing 3. When the locking mechanism is released the inner charging port casing moves from the first position to the second position by the force of the spring 71. To return the inner charging port casing 3 to the first position, the inner charging port casing 3 can be pushed into the outer charging port casing 2 and the locking mechanism reengaged.

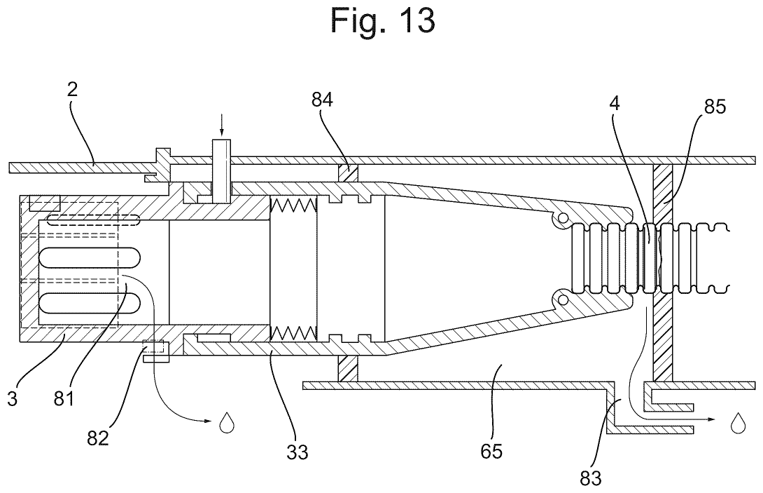

One potential problem with the charging device 1 is liquid ingress. As shown in FIG. 13, the inner charging port casing 3 may comprise one or more liquid egress openings 81, 82. A first liquid egress opening 81 may be provided in the recesses 32 and open into a hollow portion within the inner charging port casing 3. A second egress opening 82 may be provided in an outer wall of the inner charging port casing 3, as shown. A third liquid egress opening 83 may be provided in the conduit 65 housing the cable 4 to egress liquid from the cable 4. As shown, the inner surface of the conduit 65 may comprise deformable members, e.g. formed from an elastomer or foam, for removing liquid from the casing 33 and the cable 4 like a squeegee.

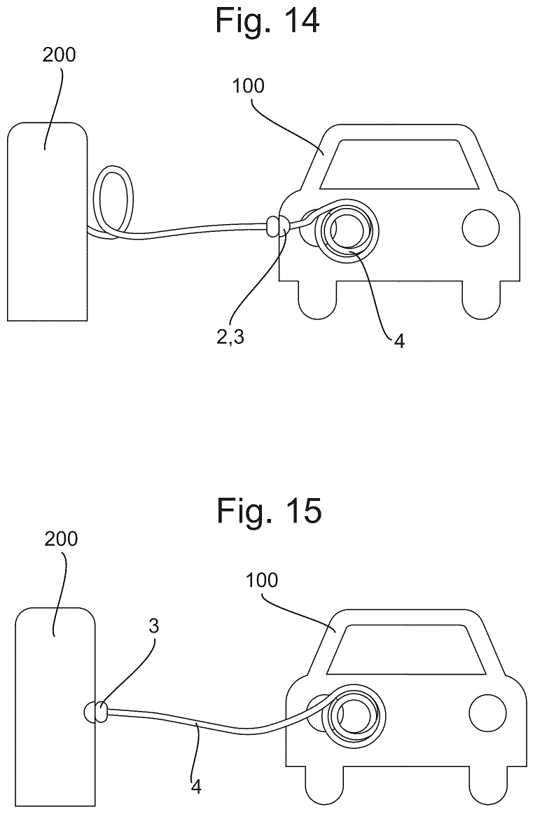

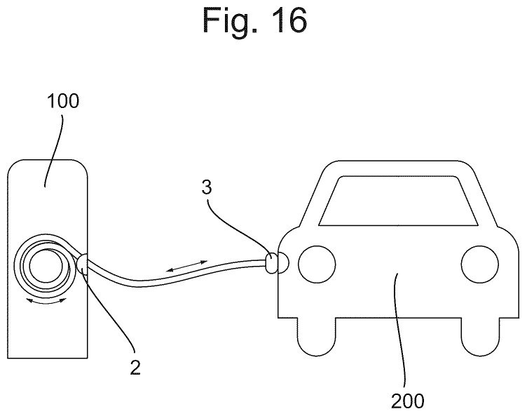

FIGS. 14 to 16 show examples of first and second electrical devices comprising the charging device described above. FIGS. 14 and 15 show examples in which the first electrical device 100 is an electric vehicle and the second electrical device 200 is an electric vehicle charger. FIG. 14 shows the charging device 1 in the first mode of operation. FIG. 15 shows the charging device 1 in the second mode of operation. FIG. 16 shoes an example in which the first electrical device 100 is an electric vehicle charger and the second electrical device 200 is an electric vehicle, and in which the charging device 1 is in the second mode of operation.

The charging device 1 may be housed within the first electrical device 100. For example, the outer charging port casing 2 may be arranged within an opening in a main body of the electrical device, e.g. an opening in a panel on the outside of an electric vehicle.

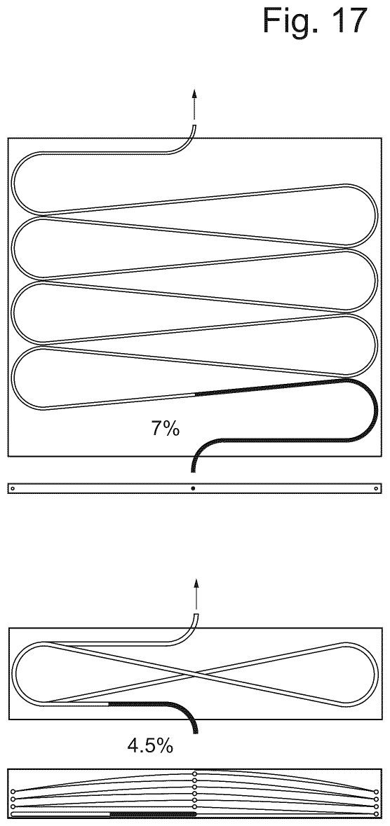

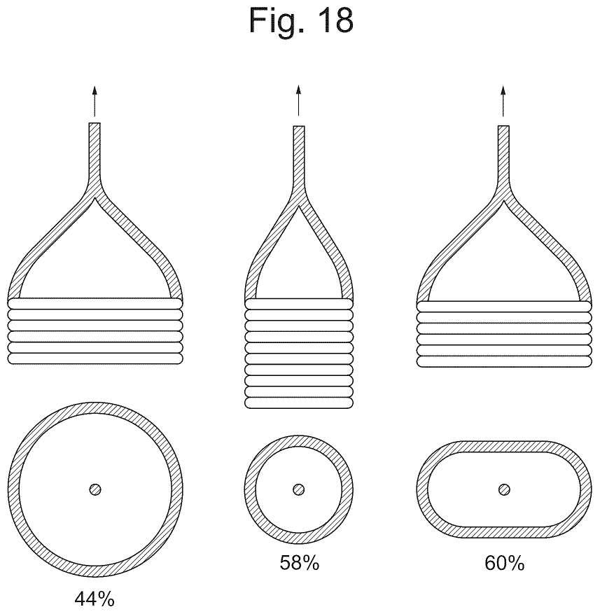

FIG. 17 shows comparative examples of serpentine cable stores and the relatively low percentages (4.5, 7, 8%) of space envelope utilised by the retracted cable. FIG. 18 shows examples of wound conduit stores according to the disclosure and the relatively high percentages (44, 58, 60%) of space envelope utilised by the retracted cable.

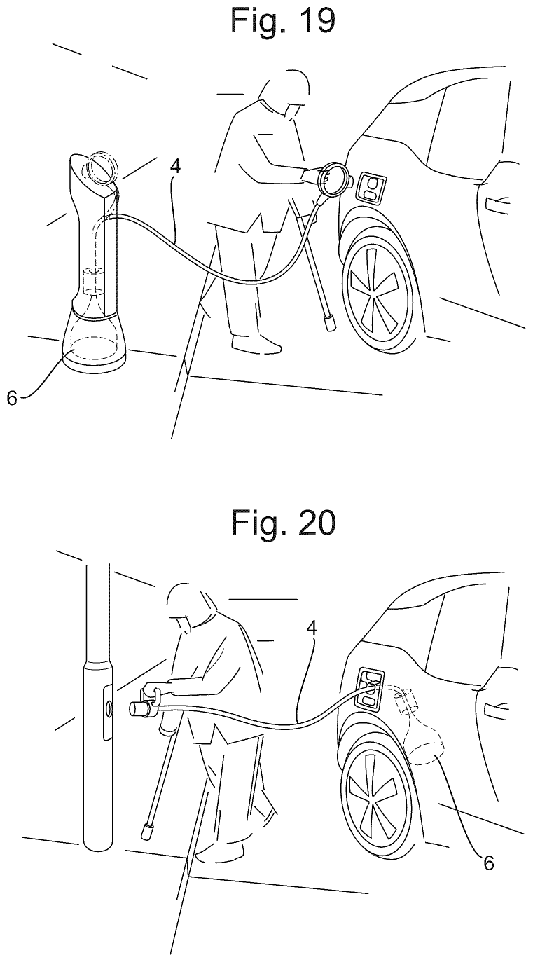

FIG. 19 shows an example charging cable and connector extending from an example cable store 6 in an example on-street charger to an example charging port in an example electric vehicle. FIG. 20 shows an example charging cable and connector extending from an example cable store 6 in an example electric vehicle to an example charging port in an example on-street charger.

In other examples, the charging device 1 may be used to discharge an electric vehicle battery to provide electricity to a grid network or to provide power to various other systems.

It should be understood that variations of the above described examples are possible in light of the above teachings, without departing from the spirit or scope of the disclose as defined by the claims. For example, features described with reference to one example may be combined with features described with reference to another example.

1. A cable store for a charging device, the charging device for charging and/or discharging an electrical device, the cable store comprising:
a drum portion around which a cable of the charging device is configured to be wound;
a deflection portion configured to deflect the cable to wind around the drum portion;
wherein the cable is configured to enter the deflecting portion substantially in a direction corresponding to an axial direction of the drum portion and wind around the drum portion substantially in a direction corresponding to a circumferential direction of the drum portion.

2. The cable store of claim 1, wherein the drum portion is stationary.

3. The cable store of claim 1 or 2, wherein the deflecting portion is stationary.

4. The cable store of any preceding claim, wherein the cable store is configured such that the cable automatically winds around the drum portion as the cable is moved into the deflecting portion.

5. The cable store of any preceding claim, wherein the drum portion comprises inner and outer drum portions forming a cavity therebetween.

6. The cable store of claim 6 or 7, wherein the cavity is configured to constrain the movement of the cable in a direction substantially perpendicular to a surface of the drum portion, but is configured to permit movement in a direction parallel to a surface of the drum portion.

7. The cable store of any preceding claim, wherein the deflecting portion comprises inner and outer deflecting portions forming a cavity therebetween.

8. The cable store of claim 6 or 7, wherein the cavity is configured to constrain the movement of the cable in a direction substantially perpendicular to a surface of the deflecting portion, but is configured to permit movement in a direction parallel to a surface of the deflecting portion.

9. The cable store of claim 7 or 8, when dependent on claim 5 or 6, wherein the cavity between the inner and outer drum portions is continuous with the cavity between the inner and outer deflecting portions.

10. The cable store of ay preceding claim, wherein the deflecting portion comprises an opening through which the cable enters the deflecting portion.

11. The cable store of any preceding claim, wherein the drum portion has a substantially circular or oval cross-section.

12. The cable store of any preceding claim, wherein the deflecting portion is a convex portion arranged at one end of the drum portion.

13. The cable store of any preceding claim, wherein the deflecting portion comprises a dome portion configured to deflect the cable to the drum portion.

14. The cable store of any preceding claim, wherein the deflecting portion comprised a tapered-portion configured to deflect the cable to the dome portion.

15. The cable store of claim 14, wherein the tapered portion is substantially cone-shaped.

16. A charging device for charging and/or discharging an electrical device, the charging device comprising:
a cable; and
a cable store according to any one of the previous claims.

17. The charging device of claim 16, wherein the cable comprises one or more wherein the cable comprises one or more mechanical slip rings configured to allow different portions of the cable to rotate relative to each other.

18. The charging device of claim 17, wherein the cable comprises an outer conduit and inner electrical cables, and the different portions of the outer electrical conduit portions are configured to rotate relative to each other.

19. The charging device of claim 17 or 18, wherein the mechanical slip ring comprises first and second parts connected together, the first part being inserted into the second part to form a mechanical connection between first and second sections of the cable that allows rotation of the first and second sections of the cable.

20. The charging device of claim 19, wherein the first part comprises one or more clips configured to connect the first part to the second section of the cable, and the second part comprises an O-ring configured to form a seal between the second section of the cable and an outer wall of the first part.

21. The charging device of any one of claims 16 to 20, comprising a connector at a distal end of the cable, the connector being configure to connect the charging device to a second electrical device for charging and/or discharging the electrical device.

22. The charging device of claim 21, wherein the connector is configured to perform AC charging and/or discharging.

23. The charging device of claim 21 or 22, wherein the connector has an arrangement corresponding to a CCS2 standard or a Type 2 standard.

24. The charging device of any one of claims 16 to 23, wherein the cable is configured to be manually moved into and/or out of the cable store.

25. The charging device of any one of claims 16 to 24, comprising a cable drive unit, configured to drive the cable into and/or out of the cable store.

26. The charging device of claim 25, when dependent on claim 21, wherein the cable drive unit is operable by a switch located on the connector.

27. The charging device of claim 25, when dependent on claim 21 or claim 26, wherein the cable drive unit is operable by a switch located on the outer charging port casing or on the electrical device.

28. The charging device of any one of claims 25 to 27, wherein the charging device comprises one or more sensors configured to sense cable position and/or cable speed, and a control device configured to control the drive unit based on the sensed cable position and/or speed.

29. The charging device of any one of claims 25 to 27, wherein the cable drive unit comprises a cable drive mechanism configured to engage with an outer surface of the cable.

30. The charging device of claim 29, wherein the outer surface of the cable is textured to enable engagement with cable drive mechanism.

31. The charging device of claim 30, wherein the outer surface of the cable is convoluted.

32. An electric vehicle comprising the cable store or charging device of any preceding claim, wherein the electric vehicle is the electrical device.

33. A charger for an electric vehicle comprising the cable store or charging device of any one of claims 1 to 31, wherein the charger is the electrical device.
